(19) United States
(12) Patent Application Publication
(10) Pub. No.: US 2007/0250412 A1
(43) Pub. Date: Oct. 25, 2007

(54) Method and system for determining suitability to enter a worksite and to perform an operation

(75) Inventor: Noel Wayne Anderson, Fargo, ND (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/400,878

(22) Filed: Apr. 10, 2006

(51) Int. Cl. G06Q 10/00

(52) U.S. Cl. 705/28

(57) ABSTRACT

A geographic unit control method including the steps of positioning ground equipment, evaluating an effect, and denying execution of an operation. Ground engaging equipment is positioned proximate to the geographic unit. An evaluation of an effect to the geographic unit, an other geographic unit adjacent to the geographic unit, a crop growing in the geographic unit and/or a future crop to be grown in the geographic unit if the ground engaging equipment performs an operation in the geographic unit. Execution of the operation is denied if the effect of the operation is not authorized.

### FIELD OF THE INVENTION

The present invention relates to a method and apparatus for determining the suitability to enter a worksite, and, more particularly to a method and apparatus for determining suitability to enter a worksite and perform an operation beneficial to the worksite.

### BACKGROUND OF THE INVENTION

The cost of food borne contamination is a concern and knowledge as to when and how the contamination was introduced can lead to improvements that prevent the contamination or allow early detection and remediation of the contamination. There are many places along the food chain where contamination can enter, thereby disrupting the purity of the food chain. The field in which the food is grown is the first opportunity for the introduction of a contamination into the food chain. Contamination can be transferred from field to field by water, wind and machinery and other methods accidental or malicious. The contamination being considered may be natural, such as bacteria, viruses, fungi and parasites. The contamination may also be manmade such as pesticides, herbicides or other chemicals.

Significant gains have been made in recent years in food traceability in the food chain; the traceability typically starts at the pallet or bin level where the food is stored. Traceability does not prevent contamination, it only facilitates the recalls of products that have been determined to be contaminated and provides a method for tracing back the contaminated foodstuff to provide records for the determination of where the contamination was introduced into the food chain.

What is needed in the art is a method and apparatus to prevent the contamination from occurring.

### SUMMARY OF THE INVENTION

The present invention includes a method that controls entry into a field to prevent contamination thereto.

The invention comprises, in one form thereof, a geographic unit control method including the steps of positioning ground equipment, evaluating an effect, and denying execution of an operation. Ground engaging equipment is positioned proximate to the geographic unit. An evaluation of an effect to the geographic unit, an other geographic unit adjacent to the geographic unit, a crop growing in the geographic unit and/or a future crop to be grown in the geographic unit if the ground engaging equipment performs an operation in the geographic unit. Execution of the operation is denied if the effect of the operation is not authorized.

### BRIEF DESCRIPTION OF THE DRAWINGS

FIG. 1 is a schematical representation of an embodiment of a system to control the access to agricultural fields of the present invention; and

FIG. 2 depicts an embodiment of a method of the present invention used to control the apparatus of FIG. 1.

### DETAILED DESCRIPTION OF THE INVENTION

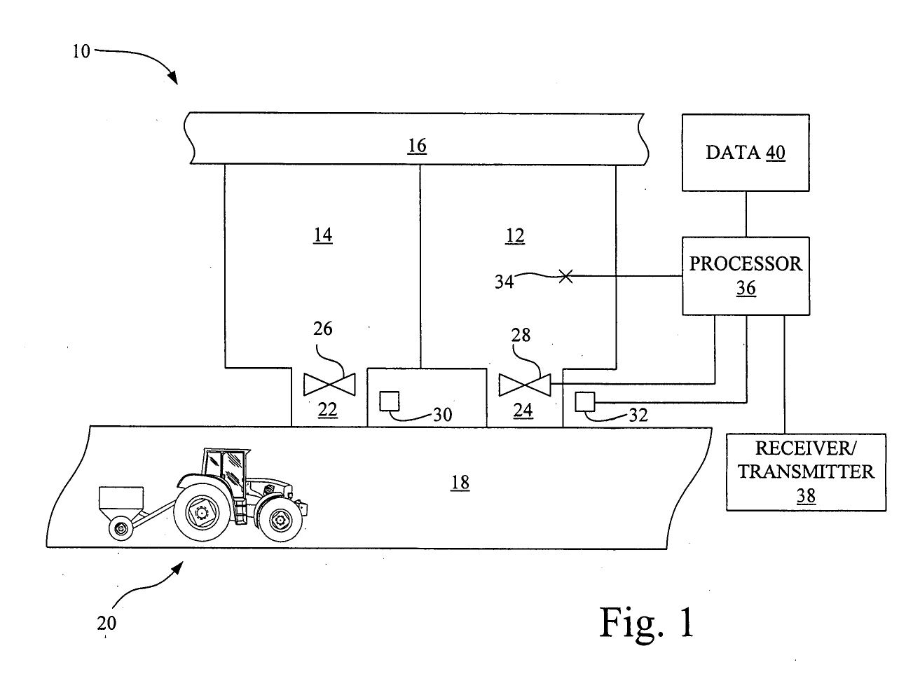

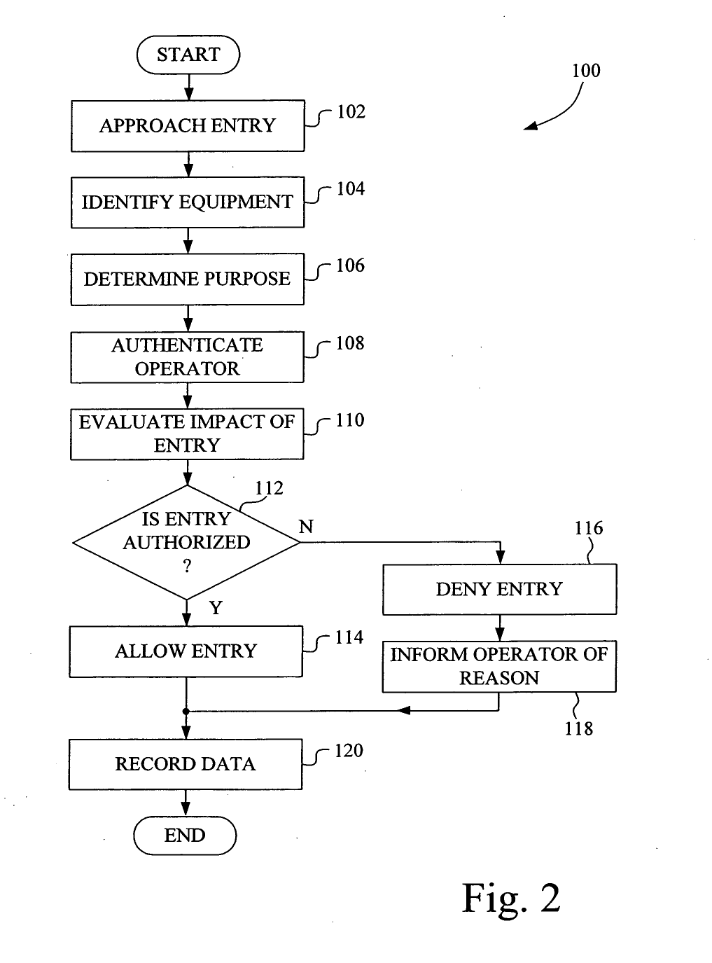

Referring now to the drawings, and more particularly to FIGS. 1 and 2, there is illustrated a geographical unit control system 10, which may also be an agricultural control system 10 that is illustrated relative to a fresh produce field 12 and an adjacent field 14. A water source such as irrigation water 16 may flow past the property and may be a source of contamination. A road 18 provides a transportation route for agricultural ground engaging equipment 20 to access entry points 22 and 24 of fields 14 and 12. Barriers 26 and 28 are under control of processor 36, which may be hardwired or wirelessly linked with control mechanisms associated with barriers 26 and 28.

Fields 12 and 14 are geographical units 12 and 14, which may be thought of as locations for which entry is controlled by the method of the present invention. For purposes of clarity and to promote understanding of the invention an agricultural system is featured in this description. However, the control of geographical units for other purposes is also contemplated. For example, control of —a landfill operation, an area having hazards therein, a worksite, a woodlot, a mining operation, a disaster area and an explosively mined area.

An operator of ground engaging equipment 20 approaches entry point 24 of field 12. The identity of ground engaging equipment 20 is determined by an information interface 30 or 32 depending on the location of equipment 20 in either entry point 22 or 24, respectively. Information obtained by data gathering device 32 includes the identity of equipment 20, which for purposes of illustration includes a tractor and a towed piece of equipment. The identity of both the tractor and the towed agricultural equipment is communicated to processor 36 for evaluation. Information about field 12 may be additionally obtained by way of a field information node 34 positioned within field 12.

Processor 36 interfaces with a control system for barrier 28 and with information interface 32. A receiver/transmitter 38 provides wireless communication with barrier 26, information interface 30 and agricultural equipment 20. Data is stored in data storage 40, which may be local with processor 36 or stored in a database that is communicatively linked with processor 36. Processor 36 may additionally have connections with predictive sources, such as future weather conditions and the contents and flow rates of water 16.

While the present invention is directed to the case of preventing human illness caused by contaminated produce in the food chain, it is also applicable to the transfer of plant diseases from fields that have had tilling, spraying and harvesting equipment therein. The present invention is also applicable to preventing livestock illnesses from being transferred from feedlots or buildings to other animal locations or to places of manure distribution. Additionally, tree and turf type diseases that may be transferred between logging and mowing sites are also contemplated to be within the scope of the present invention. The effects considered include the impact not only to field 12 but the impact upon an adjacent field 14 by a proposed operation on field 12. Additionally, effect upon the water 16 or the effect on field 12 by the interaction of water 16 with the proposed operation are also considered by elements of method 100 to determine whether equipment 20 should be allowed to enter into field 12.

One embodiment of the method for the present invention includes method 100, which includes the steps of approaching entry 24 by equipment 20. As equipment 20 approaches entry 24, at step 102, an identification step 104 is carried out by the identifying of equipment 20 by way of information interface 32. The identification of equipment 20 may take place by way of a radio frequency identification tag on both the tractor and the towed apparatus. Another manner in which identification of equipment 20 may be carried out is by way of a global positioning system that interacts with receiver transmitter 38 to report the position and vehicle identification of equipment 20. Alternatively, an operator may initiate manual entry of an access code on information interface 32. Data accessed by processor 36 is used to determine the previous locations of equipment 20 to determine if equipment 20 has visited another field in which there is a known contamination by disease or chemicals. Further, processor 36 has access to information to determine whether equipment 20 has been through a decontamination procedure or if field 12 has a contamination similar to a field previously visited by equipment 20 such that no new contamination would result by entry into field 12.

At step 106, the purpose of agricultural equipment 20 in field 12 is determined by the identification of equipment 20 as well as information as to any chemicals being carried by equipment 20 for the proposed operation in field 12.

Several agricultural operations require a certification or license to perform that operation. At step 108, the operator of equipment 20 is authenticated by identifying the operator and determining whether the operator has been properly certified to perform the proposed operation to field 12. The operator identification and authentication can be done by way of cross-referencing records contained in data 40. The identification step may be by way of a biometric identification system that occurs by way of information interface 32.

Evaluation of the impact of entry is determined at step 110 by evaluating the proposed operation to be performed by equipment 20 upon field 12. For example, if harvest is to occur in field 12 at a specific point in time and the proposed operation is a spraying operation the evaluation would include the effect of the chemical upon the delivered grain if harvested at the proposed period of time. If the spraying would be within the predetermined time then authorization for entry into the field will be denied. Further, if field 12 is contaminated and equipment 20 has been scheduled to enter other fields which are not contaminated, processor 36 may deny entry and suggest to the operator, by way of interface 32, to proceed to a field that is not contaminated and to return to field 12 when the non-contaminated fields have been processed. The evaluation process includes a “safe to enter” determinant that the farm equipment may enter and perform the operation as well as a “safe to harvest” determination, which may include insitu field and weather data that may be from field information node 34 or other predictive sources apart from field 12. Such information includes soil type, topography, rainfall, temperature, irrigation water amounts and sources as well as external field and weather data to determine whether it is appropriate to harvest the crop in field 12. The records kept in data 40 of field operations in field 12 and adjacent field 14, and an evaluation of the impact upon field 12 of the execution of the proposed operation proceeds is analyzed by method 100. Additionally, visual surveillance records for the entry of animals and people into field 12 may require further evaluation of the contamination or potential contamination of a field 12. Cross references to the prior use of chemicals in field 12 have been applied or otherwise brought into a field during a manufacture specified or regulated period between the last application/exposure and harvest is also considered. Further determinations may also be made to evaluate the impact of weather, which may cause chemical drift from an adjacent field 14 into field 12. If a problem in field 12 does exist the identified reason may lead to the generation of a remediation plan for field 12, which may include waiting to harvest the field until a mandated waiting period has past after the application of a chemical. Further, scouting and/or laboratory analysis may be conducted to determine if cross-field contamination has occurred. Further, the harvested produced may be diverted from a fresh produce market to a processed market where a processing step may eliminate the biological and/or chemical agents from the harvested material. If this diversion is done, information may be automatically transferred from data 40 to track the product as it is eventually utilized for food or other purposes.

Once the evaluation of the impact of entry into field 12 is completed a determination is made at step 112 as to whether entry is to be authorized into field 12. If entry is authorized then barrier 28 is removed at step 114. Alternatively if entry is not authorized, at step 116, then barrier 28 is retained in position and the reason for the denial of entry is provided to the operator on information interface 32, at step 118. Although barrier 28 has been illustrated as a method of preventing entry, other methods are also possible such as using a geofencing technique, which would cause agricultural equipment 20 to become immobilized upon entry into field 12. This can be accomplished by tracking the position of equipment 20 using a GPS method and using that information to disrupt the function of equipment 20 if it crosses a boundary of field 12. Prior to the disruption of equipment 20 a warning would be issued to the operator that this was about to occur if the operator continued to enter field 12.

Information is recorded at step 120 which includes the time the operator spent in field 12, the operation that was undertaken, information from field information node 34 during the time of the performance of the operation by equipment 20. Other sensory information from field information node 34 may include weather conditions during the application and other observable information about the application. The recorded data is then available to evaluate performance of agricultural equipment 20 and becomes logged with the information being available for a subsequent entry of equipment 20 into another field.

Having described the preferred embodiment, it will become apparent that various modifications can be made without departing from the scope of the invention as defined in the accompanying claims.

1. A geographic unit control method, comprising the steps of:
positioning ground engaging equipment proximate to the geographic unit;
evaluating an effect to at least one of the geographic unit, an other geographic unit adjacent to the geographic unit, a crop growing in the geographic unit and a future crop to be grown in the geographic unit if said ground engaging equipment performs an operation in the geographic unit; and
denying execution of said operation if said effect of said operation is not authorized.

2. The method of claim 1, further comprising the step of authorizing entry to the geographic unit if said effect is authorized.

3. The method of claim 2, wherein said authorizing and said denying step take place proximate to a controlled barrier, said controlled barrier barring entry to the geographic unit if said denying step is carried out, said controlled barrier not barring entry to the geographic unit if said authorizing step is carried out.

4. The method of claim 1, further comprising the step of authenticating an operator to perform said operation in the geographic unit

5. The method of claim 4, wherein said authenticating step includes identifying the operator and determining if the operator is at least one of certified and licensed to perform said operation.

6. The method of claim 5, wherein said denying execution of said operation step is additionally carried out if the operator is not authenticated.

7. The method of claim 6, further comprising the step of authorizing entry to the geographic unit if said effect is authorized and if the operator is authenticated.

8. The method of claim 6, further comprising the step of informing the operator of a reason for denying execution of said operation.

9. The method of claim 1, wherein said denying execution of said operation step includes issuing a command to prevent operation of said ground engaging equipment if entry to the geographic unit is detected, the geographic unit being an agricultural field.

10. A geographic unit control method, comprising the steps of:
identifying ground engaging equipment proximate to the geographic unit;
evaluating an effect to at least one of the geographic unit, an other geographic unit adjacent to the geographic unit, a crop growing in the geographic unit and a future crop to be grown in the geographic unit if said ground engaging equipment performs an operation in the geographic unit; and
denying execution of said operation if said effect is not authorized.

11. The method of claim 10, further comprising the step of authorizing entry to the geographic unit if said effect is authorized.

12. The method of claim 11, wherein said identifying step includes determining if said ground engaging equipment has been exposed to at least one of contamination and a disease from another location.

13. The method of claim 12, wherein said evaluating step determines said effect of at least one of the contamination and the disease on the geographic unit.

14. The method of claim 13, wherein said denying step is additionally executed if said effect of at least one of the contamination and the disease on the geographic unit is negative.

15. The method of claim 10, further comprising the step of authenticating an operator to perform said operation in the geographic unit.

16. The method of claim 15, wherein said authenticating step includes identifying the operator and determining if the operator is at least one of certified and licensed to perform said operation.

17. The method of claim 16, wherein said denying execution of said operation step is additionally carried out if the operator is not authenticated by said authenticating step.

18. A geographic unit entry system, including:
a removable barrier;
a data gathering system proximate to said barrier, said data gathering system detectable of an identification of an earth engaging device; and
a processor interconnected to said data gathering system and to said removable barrier;

19. The geographic unit entry system of claim 18, wherein said processor causes said removable barrier to allow the earth engaging device entry into the geographic unit if a process to be carried out by the earth engaging device does not harm a crop in the geographic unit.

20. The geographic unit entry system of claim 18, wherein said data gathering system is used to authenticate an operator of said earth engaging device.
